(19) United States
(12) Patent Application Publication
(10) Pub. No.: US 2025/0190823 A1
(43) Pub. Date: Jun. 12, 2025

(54) COMPUTER-READABLE RECORDING MEDIUM, MACHINE LEARNING METHOD, INFERENCE METHOD, AND INFORMATION PROCESSING APPARATUS

(71) Applicants: Fujitsu Limited, Kawasaki-shi (JP); TOKAI UNIVERSITY EDUCATIONAL SYSTEM, Tokyo (JP)

(72) Inventors: Suguru YASUTOMI, Kawasaki (JP); Akira SAKAI, Kawasaki (JP); Kanata SUZUKI, Kawasaki (JP); Keiichi GOTO, Shizuoka (JP); Masafumi YAGI, Shizuoka (JP)

(73) Assignees: Fujitsu Limited, Kawasaki-shi (JP); TOKAI UNIVERSITY EDUCATIONAL SYSTEM, Tokyo (JP)

(21) Appl. No.: 18/951,668

(22) Filed: Nov. 19, 2024

(30) Foreign Application Priority Data
Dec. 8, 2023 (JP) 2023-207946

(51) Int. Cl. G06N 5/04

(52) U.S. Cl. CPC G06N 5/04

(57) ABSTRACT

A computer is caused to execute a process including: acquiring a training data set including a plurality of pieces of training data in which a plurality of A-mode ultrasonic signals obtained for each of different positions of an object are associated with evaluation results for the object, and for each of the plurality of pieces of training data, weighting a plurality of pieces of feature data acquired based on the plurality of A-mode ultrasonic signals, by using a weighting model that weights feature data, acquiring inference results of evaluation for the object by inputting the plurality of pieces of weighted feature data to a classification model that outputs inference results of evaluation in response to input of the plurality of pieces of feature data, and training the weighting model and the classification model based on the inference results and the evaluation results in the training data.

### CROSS-REFERENCE TO RELATED APPLICATION

This application is based upon and claims the benefit of priority of the prior Japanese Patent Application No. 2023-207946, filed on Dec. 8, 2023, the entire contents of which are incorporated herein by reference.

### FIELD

The embodiments discussed herein are related to a computer-readable recording medium, a machine learning method, an inference method, and an information processing apparatus.

### BACKGROUND

Low-frequency ultrasound is commonly used for nondestructive inspections of solids such as concrete structures and frozen objects. In inspections using low-frequency ultrasound, an ultrasonic probe is large in order to output the low-frequency ultrasound. Therefore, inspections are often performed using amplitude (A) mode ultrasonic signals obtained using a single ultrasonic probe and displaying amplitude information on a time axis.

Specifically, an A-mode ultrasonic signal is obtained by detecting ultrasonic pulses that are transmitted from a single ultrasonic probe to an object in a certain direction, reflected by the object, and received back by the ultrasonic probe. A graph illustrating the A-mode ultrasonic signal represents time on a horizontal axis and the intensity of a reflected wave on a vertical axis. The graph illustrating the A-mode ultrasonic signal provides the amplitude and intensity of the reflected wave, and the internal state of the object to be inspected is obtained using the amplitude and intensity of the reflected wave.

Handling methods of the ultrasonic probe for acquiring the A-mode ultrasonic signal include a method of manually pressing the ultrasonic probe against the object, and a method of mechanically pressing the ultrasonic probe against the object. However, no matter which method is used, performing accurate analysis is difficult when the obtained A-mode ultrasonic signal is used as is because the A-mode ultrasonic signal is prone to noise and the quality of data greatly varies depending on the condition of a contact surface of the ultrasonic probe.

Therefore, related art has proposed a method of averaging A-mode ultrasonic signals acquired continuously by continuously applying an ultrasonic probe to the same measurement site. The related art has also proposed a method of averaging signals acquired by applying an ultrasonic probe to each of different measurement sites of the same object. In addition, the related art has proposed other techniques of using machine learning models trained using scores for a single A-mode signal to infer scores for each of a plurality of A-mode ultrasonic signals obtained from different measurement sites on the same non-specimen and calculate the average of the scores.

As an inspection technique using ultrasound, a technique has been proposed to, by using an ultrasonic inspection apparatus, measure the volume elastic modulus, acoustic impedance, attenuation constant, and Doppler shift frequency values of ultrasonic tomographic images and ultrasonic tissue characteristic values of tuna, and to evaluate quality based on the measurement results.
Patent Document 1: Japanese Laid-open Patent Publication No. 2007-155692

### SUMMARY

According to an aspect of an embodiment, a non-transitory computer-readable recording medium stores therein a machine learning program that causes a computer to execute a process including, acquiring a training data set including a plurality of pieces of training data in which a plurality of A-mode ultrasonic signals obtained for each of different positions of an object are associated with evaluation results for the object, and for each of the plurality of pieces of training data included in the training data set, weighting a plurality of pieces of feature data acquired based on the plurality of A-mode ultrasonic signals included in the training data, by using a first machine learning model that weights feature data, acquiring inference results of evaluation for the object by inputting the plurality of pieces of feature data weighted by the first machine learning model to a second machine learning model that outputs inference results of evaluation in response to input of the plurality of pieces of feature data, and training the first machine learning model and the second machine learning model based on the inference results and the evaluation results in the training data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an information processing apparatus according to an embodiment;

FIG. 2 is an image diagram of an entire quality inference process by an inference unit according to a first embodiment;

FIG. 3 is a diagram for explaining the generation of a training data set in a training execution unit;

FIG. 4 is a flowchart of a machine learning process in a training phase by the information processing apparatus according to the first embodiment;

FIG. 5 is a flowchart of an inference process in an inference phase by the information processing apparatus according to the first embodiment;

FIG. 6 is an image diagram of an entire quality inference process by an inference unit according to a second embodiment; and

FIG. 7 is a hardware configuration diagram of the information processing apparatus.

### DESCRIPTION OF EMBODIMENTS

Some ultrasonic signals are not represented by images or the like, and in this case, whether an appropriate signal has been obtained is often unclear. Therefore, the performance of quality evaluation using ultrasonic signals may be degraded.

For example, in a technique of averaging A-mode ultrasonic signals continuously acquired by continuously applying an ultrasonic probe to the same measurement site, improving the performance of quality evaluation is difficult because a signal change when the probe is continuously applied is negligibly small. In a technique of averaging signals acquired by applying an ultrasonic probe to different measurement sites on the same object, simply averaging the signals is inappropriate because information possessed by A-mode ultrasonic signals obtained from different measurement sites is also changed, and improving the performance of quality evaluation is difficult. In a technique of calculating the average of scores for A-mode ultrasonic signals obtained from machine learning models, the obtained A-mode ultrasonic signals may include noise with a high possibility, and the performance of quality evaluation may be degraded by being pulled down by scores derived from noisy signals.

Preferred embodiments of the present invention will be explained with reference to accompanying drawings. The following embodiments do not limit the computer-readable recording medium, the machine learning method, the inference method, and the information processing apparatus disclosed in the present application.

### (a) First Embodiment

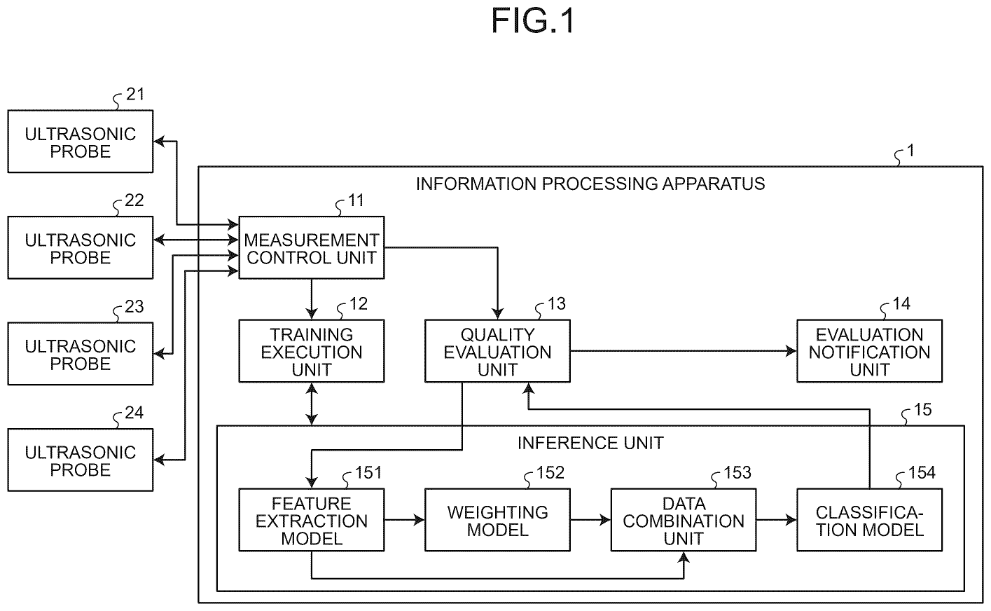

FIG. 1 is a block diagram illustrating an information processing apparatus according to an embodiment. An information processing apparatus 1 is connected to ultrasonic probes 21 to 24. In the following description, each of the ultrasonic probes 21 to 24 is referred to as an “ultrasonic probe 20” when not distinguished. The information processing apparatus 1 is an apparatus that measures the internal state of an object by using A-mode ultrasonic signals obtained from the object by the ultrasonic probes 21 to 24. The present embodiment describes a case in which frozen tuna is used as an object and the four ultrasonic probes 21 to 24 are used to make measurements on different measurement sites of the frozen tuna. In in the present embodiment, the four ultrasonic probes 21 to 24 are used for measurement; however, the number of ultrasonic probes 20 is not particularly limited. For example, eight ultrasonic probes 20 can also be used, and the accuracy of quality evaluation is improved as the number of used ultrasonic probes 20 increases.

The information processing apparatus 1 has a measurement control unit 11, a training execution unit 12, a quality evaluation unit 13, an evaluation notification unit 14, and an inference unit 15. The inference unit 15 has a feature extraction model 151, a weighting model 152, a data combination unit 153, and a classification model 154. The information processing apparatus 1 has two operating phases: a training phase and an inference phase. In the training phase, the information processing apparatus 1 trains machine learning models used for inference of quality evaluation: the feature extraction model 151, the weighting model 152, and the classification model 154. In the inference phase, the information processing apparatus 1 infers quality evaluation by using the trained feature extraction model 151, the weighting model 152, and the classification model 154 for the frozen tuna for which a correct answer to quality evaluation is unknown.

The measurement control unit 11 receives and retains in advance, from an input device (not illustrated), information on the ultrasonic irradiation settings, such as frequency, power, and direction, used for ultrasonic measurements on the frozen tuna. The measurement control unit 11 receives, from the input device, an instruction to execute the measurement. Subsequently, the measurement control unit 11 transmits the information on irradiation settings to each of the ultrasonic probes 21 to 24 attached to the frozen tuna, and causes the ultrasonic probes 21 to 24 to emit ultrasonic waves to the frozen tuna. Since the information processing apparatus 1 according to the present embodiment performs measurement using A-mode ultrasonic signals, the measurement control unit 11 causes the ultrasonic probes 21 to 24 to output ultrasonic waves in a low frequency band of several hundred kHz. For example, the measurement control unit 11 causes the ultrasonic probes 21 to 24 to output ultrasonic waves of 500 kHz.

Subsequently, the measurement control unit 11 acquires the A-mode ultrasonic signals, which are reflected signals of the ultrasonic waves received from each of the ultrasonic probes 21 to 24 and propagated through the frozen tuna. When the operating phase is the training phase, the measurement control unit 11 outputs the acquired A-mode ultrasonic signals at each measurement site to the training execution unit 12. When the operating phase is the inference phase, the measurement control unit 11 outputs the acquired A-mode ultrasonic signals at each measurement site to the quality evaluation unit 13.

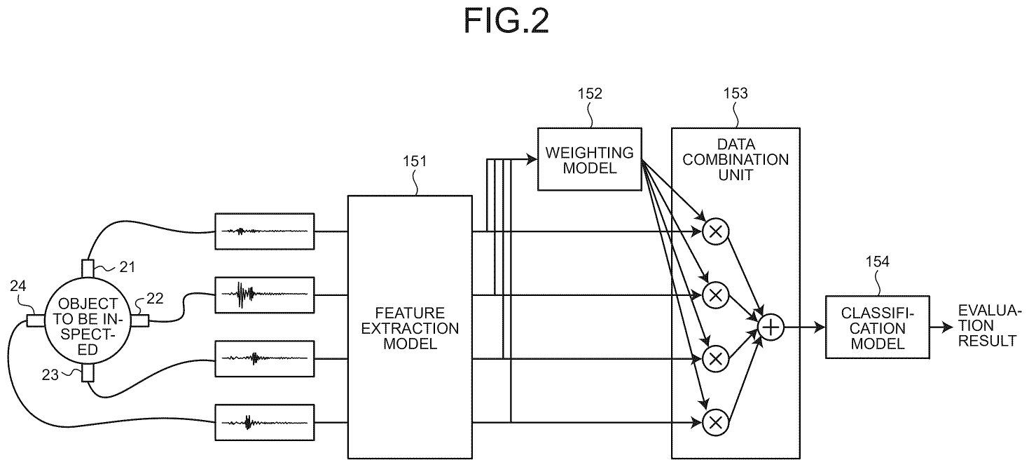

The inference unit 15 receives the A-mode ultrasonic signals at each measurement site, infers quality evaluation of the frozen tuna by using the feature extraction model 151, the weighting model 152, the data combination unit 153, and the classification model 154, and outputs results of the inferred quality evaluation. The feature extraction model 151, the weighting model 152, and the classification model 154 can use, for example, a neural network. FIG. 2 is an image diagram of an entire quality inference process by the inference unit according to the first embodiment.

As illustrated in FIG. 2, the feature extraction model 151 receives the A-mode ultrasonic signals at each measurement site of the frozen tuna. In the present embodiment, the feature extraction model 151 receives four A-mode ultrasonic signals corresponding to the ultrasonic probes 21 to 24, respectively. Subsequently, the feature extraction model 151 extracts a feature of each of the input A-mode ultrasonic signals and outputs feature data including information on the extracted feature. Conceptually, the feature is information containing a compilation of the amplitude information, frequency information, and the like of the A-mode ultrasonic signal. In the present embodiment, the feature extraction model 151 outputs four pieces of feature data corresponding to four measurement sites.

The feature extraction model 151 is an example of a “third machine learning model”. That is, for a plurality of A-mode ultrasonic signals included in training data 200, feature data for each of the plurality of A-mode ultrasonic signals is generated using the third machine learning model.

As illustrated in FIG. 2, the weighting model 152 receives the feature data of the A-mode ultrasonic signals at each measurement site of the frozen tuna extracted by the feature extraction model 151. Subsequently, the weighting model 152 outputs a weight for each feature indicated by the input feature data. The weighting model 152 determines the weight of the feature so that, conceptually, the better the quality of measurement data, the heavier the weight. The weighting model 152 is an example of a “first machine learning model”.

The data combination unit 153 receives the feature data from the feature extraction model 151. The data combination unit 153 further receives the weight for each feature indicated by the feature data from the weighting model 152.

Subsequently, the data combination unit 153 adds the weight for each feature determined by the weighting model 152 to the corresponding feature of the A-mode ultrasonic signal at each measurement site of the frozen tuna, the features being included in the feature data. For example, the data combination unit 153 performs weighting by adding weights to the features of the A-mode ultrasonic signals. Subsequently, the data combination unit 153 generates one piece of input data by combining the weighted features together. For example, the data combination unit 153 calculates the weighted sum of the features to make one piece of input data.

As illustrated in FIG. 2, the classification model 154 receives the one piece of input data generated by the data combination unit 153. Subsequently, the classification model 154 uses the input data to classify the quality of the frozen tuna being an object as good or bad, infers the quality evaluation of the frozen tuna, and outputs results of the quality evaluation.

The classification model 154 is an example of a “second machine learning model”. That is, the one piece of input data generated by the data combination unit 153, which is a compilation of the plurality of pieces of weighted feature data, is input to the second machine learning model to obtain the inference result of the evaluation on the object.

In the training phase, the training execution unit 12 receives the A-mode ultrasonic signals at each measurement site of the frozen tuna from the measurement control unit 11. In addition, the training execution unit 12 acquires a correct answer to the quality evaluation of the frozen tuna being the object for which the acquired A-mode ultrasonic signals have been obtained. Subsequently, the training execution unit 12 trains the feature extraction model 151, the weighting model 152, and the classification model 154 by using the A-mode ultrasonic signals at each measurement site of the frozen tuna and the correct answer to the quality evaluation of the frozen tuna. Details of the operation of the training execution unit 12 are described below.

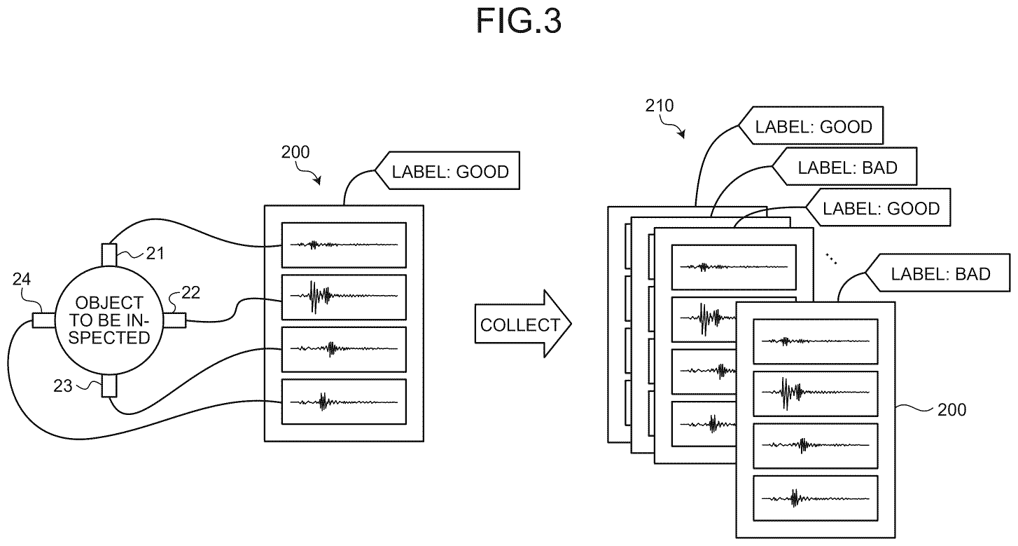

FIG. 3 is a diagram for explaining the generation of a training data set in the training execution unit. The training execution unit 12 generates the training data 200 illustrated in FIG. 3 by assigning classification labels, which indicate the correct answer to the quality evaluation corresponding to the frozen tuna, to the A-mode ultrasonic signals at each measurement site of the frozen tuna obtained by the ultrasonic probes 21 to 24.

The training execution unit 12 acquires a plurality of A-mode ultrasonic signals for each measurement site of the frozen tuna obtained by the ultrasonic probes 21 to 24, and generates a plurality of pieces of training data 200 by assigning a classification label to each of the plurality of A-mode ultrasonic signals for each measurement site in the same manner. Subsequently, the training execution unit 12 collects the generated training data 200 to generate a training data set 210 illustrated in FIG. 3. In this way, the training execution unit 12 acquires the training data set 210 including a plurality of pieces of training data 200 in which a plurality of A-mode ultrasonic signals obtained for each of different positions of the object are associated with evaluation results for the object.

Subsequently, the training execution unit 12 performs the following processing on each of the training data 200 included in the training data set 210. The training execution unit 12 inputs the A-mode ultrasonic signals included in the training data 200 to the feature extraction model 151. The input A-mode ultrasonic signals are sequentially processed by the feature extraction model 151, the weighting model 152, the data combination unit 153, and the classification model 154. Subsequently, the training execution unit 12 acquires results of quality evaluation corresponding to the input A-mode ultrasonic signals and output from the classification model 154. Subsequently, the training execution unit 12 compares the results of the quality evaluation output from the classification model 154 with the correct answer to the quality evaluation included in the training data 200, and adjusts and updates parameters of the feature extraction model 151, the weighting model 152, and the classification model 154.

The training execution unit 12 repeats training of the feature extraction model 151, the weighting model 152, and the classification model 154 described above until predetermined training termination conditions are satisfied. The training termination conditions are specified using an upper limit of the number of trials, an upper time limit, a convergence status of inferred results, and the like. When the predetermined training termination conditions are satisfied, the training execution unit 12 terminates the training of the feature extraction model 151, the weighting model 152, and the classification model 154. In this way, the trained feature extraction model 151, the weighting model 152, and classification model 154 are generated.

In the present embodiment, the feature extraction model 151, the weighting model 152, and the classification model 154 are trained together; however, the training method is not limited thereto. For example, a model that has been trained may be used for the feature extraction model 151, and the training execution unit 12 may train the weighting model 152 and the classification model 154 by using the features obtained by inputting the A-mode ultrasonic signals to the feature extraction model 151 and the correct answer to the quality evaluation. In this case, the parameters of the weighting model 152 and the classification model 154 are appropriately adjusted according to the training data 200.

In this way, the training execution unit 12 performs the following processes for each training data 200 included in the training data set 210. The training execution unit 12 weights the plurality of pieces of feature data acquired based on the plurality of A-mode ultrasonic signals included in the training data 200, by using the first machine learning model that weights feature data. Subsequently, the training execution unit 12 inputs the plurality of pieces of feature data weighted by the first machine learning model into the second machine learning model, which outputs inference results of evaluation in response to the input of the plurality of pieces of feature data, to acquire inference results of evaluation for the object. Subsequently, the training execution unit 12 trains the first machine learning model and the second machine learning model based on the inference results and the evaluation results in the training data 200.

Returning to FIG. 1, the explanation is continued. In the inference phase, the quality evaluation unit 13 receives the A-mode ultrasonic signals at each measurement site of the frozen tuna from the measurement control unit 11. Subsequently, the quality evaluation unit 13 inputs the acquired A-mode ultrasonic signals at each measurement site to the feature extraction model 151. The input A-mode ultrasonic signals are sequentially processed by the feature extraction model 151, the weighting model 152, the data combination unit 153, and the classification model 154. Subsequently, the quality evaluation unit 13 acquires the results of the quality evaluation output from the classification model 154 and corresponding to the input A-mode ultrasonic signals. Subsequently, the quality evaluation unit 13 outputs the acquired results of the quality evaluation to the evaluation notification unit 14.

The evaluation notification unit 14 receives the results of the quality evaluation for the frozen tuna being the object from the quality evaluation unit 13. Subsequently, the evaluation notification unit 14 notifies a user of the results of the quality evaluation for the frozen tuna being the object by display of the results on a display device (not illustrated), or the like.

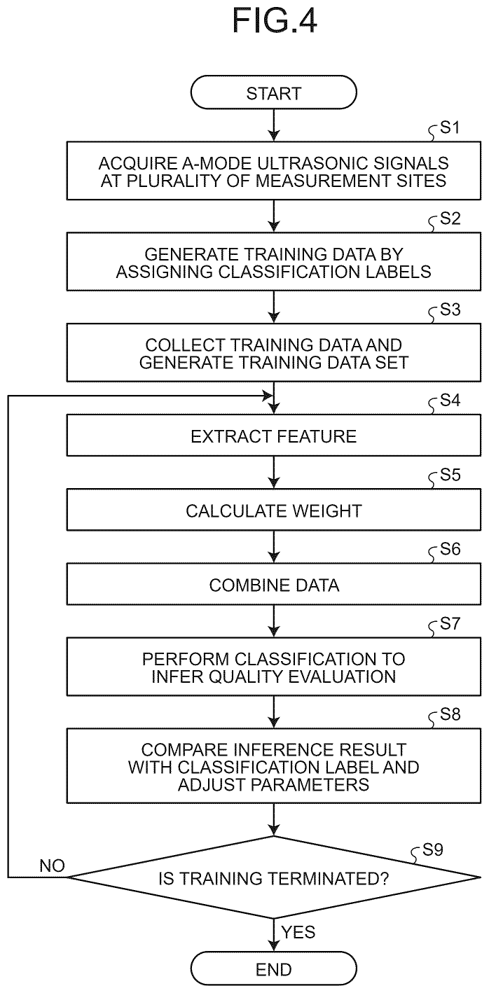

FIG. 4 is a flowchart of the machine learning process in the training phase by the information processing apparatus according to the first embodiment. The flow of the machine learning process in the training phase by the information processing apparatus 1 according to the first embodiment is described below with reference to FIG. 4.

The measurement control unit 11 transmits information on irradiation settings to each of the ultrasonic probes 21 to 24 attached to the frozen tuna, and causes the ultrasonic probes 21 to 24 to emit ultrasonic waves to the frozen tuna. Subsequently, the measurement control unit 11 acquires the A-mode ultrasonic signals, which are reflected signals of the ultrasonic waves received from each of the ultrasonic probes 21 to 24 and propagated through the frozen tuna. Subsequently, the measurement control unit 11 acquires the A-mode ultrasonic signals, which are reflected waves from the frozen tuna at each measurement site, from the ultrasonic probes 21 to 24 (step S1). The measurement control unit 11 outputs the acquired A-mode ultrasonic signals at each measurement site to the training execution unit 12.

The training execution unit 12 generates the training data 200 illustrated in FIG. 3 by assigning classification labels, which indicate the correct answer to the quality evaluation correspond to the frozen tuna, to the A-mode ultrasonic signals at each measurement site of the frozen tuna obtained by the ultrasonic probes 21 to 24 (step S2).

Subsequently, the training execution unit 12 collects a plurality of pieces of training data 200 with the classification labels for the A-mode ultrasonic signals at each measurement site, and generates the training data set 210 (step S3).

Subsequently, the training execution unit 12 inputs the A-mode ultrasonic signals at each measurement site included in each training data 200 to the feature extraction model 151. The feature extraction model 151 receives the A-mode ultrasonic signals at each measurement site, and extracts the feature of each A-mode ultrasonic signal at each measurement site (step S4).

The weighting model 152 receives the feature of each A-mode ultrasonic signal at each measurement site extracted by the feature extraction model 151, and calculates the weight for each feature (step S5).

The data combination unit 153 assigns the weight for each feature calculated by the weighting model 152 to the corresponding feature of each A-mode ultrasonic signal at each measurement site extracted by the feature extraction model 151. Subsequently, the data combination unit 153 combines the weighted features into one piece of input data by data combination (step S6).

The classification model 154 receives the input data generated by the data combination unit 153 and performs classification to infer quality evaluation (step S7).

Subsequently, the training execution unit 12 compares quality evaluation results inferred for the quality evaluation of the frozen tuna being the object with the classification label, the quality evaluation results being output from the classification model 154, and adjusts the parameters of the feature extraction model 151, the weighting model 152, and the classification model 154 (step S8).

Subsequently, the training execution unit 12 determines whether to terminate the training depending on whether the training termination conditions have been reached (step S9). When the training is to be continued (No at step S9), the training execution unit 12 returns to step S4.

In contrast, when the training is terminated (Yes at step S9), the training execution unit 12 terminates the machine learning and terminates the operation of the training phase of the information processing apparatus 1.

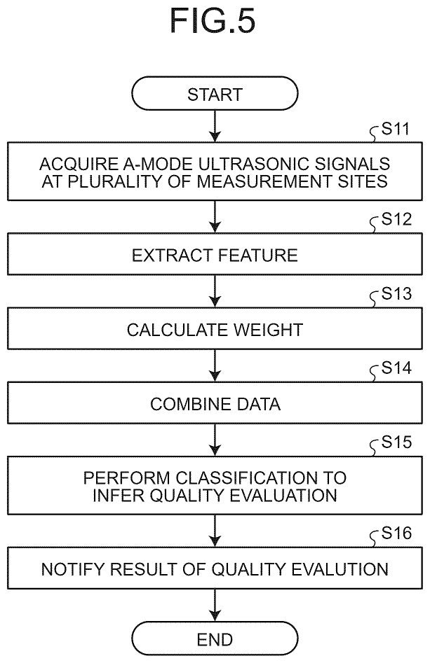

FIG. 5 is a flowchart of the inference process in the inference phase by the information processing apparatus according to the first embodiment. The flow of the inference process in the inference phase by the information processing apparatus 1 according to the first embodiment is described below with reference to FIG. 5.

The measurement control unit 11 transmits information on irradiation settings to each of the ultrasonic probes 21 to 24 attached to the frozen tuna, and causes the ultrasonic probes 21 to 24 to emit ultrasonic waves to the frozen tuna. Subsequently, the measurement control unit 11 acquires the A-mode ultrasonic signals, which are reflected signals of the ultrasonic waves received from each of the ultrasonic probes 21 to 24 and propagated through the frozen tuna. Subsequently, the measurement control unit 11 acquires the A-mode ultrasonic signals, which are reflected waves from the frozen tuna at each measurement site, from the ultrasonic probes 21 to 24 (step S11). The measurement control unit 11 outputs the acquired A-mode ultrasonic signals at each measurement site to the quality evaluation unit 13.

Subsequently, the quality evaluation unit 13 inputs the A-mode ultrasonic signals at each measurement site to the feature extraction model 151. The feature extraction model 151 receives the A-mode ultrasonic signals at each measurement site, and extracts the feature of each A-mode ultrasonic signal at each measurement site (step S12).

The weighting model 152 receives the feature of each A-mode ultrasonic signal at each measurement site extracted by the feature extraction model 151, and calculates the weight for each feature (step S13).

The data combination unit 153 assigns the weight for each feature calculated by the weighting model 152 to the corresponding feature of each A-mode ultrasonic signal at each measurement site extracted by the feature extraction model 151. Subsequently, the data combination unit 153 combines the weighted features into one piece of input data by data combination (step S14).

The classification model 154 receives the input data generated by the data combination unit 153 and performs classification to infer quality evaluation (step S15).

The evaluation notification unit 14 receives the results of the quality evaluation for the frozen tuna being the object from the quality evaluation unit 13. Subsequently, the evaluation notification unit 14 notifies a user of the results of the quality evaluation for the frozen tuna being the object by display of the results on the display device, or the like (step S16).

As described above, the information processing apparatus according to the present embodiment trains a feature extraction model, a weighting model, and a classification model by using A-mode ultrasonic signals obtained from different measurement sites and classification labels representing a correct answer to quality evaluation. Subsequently, the information processing apparatus performs quality evaluation inference on the A-mode ultrasonic signals obtained from the different measurement sites, by using the trained feature extraction model, weighting model, and classification model.

In the case of performing measurement using an ultrasonic probe, data quality deteriorates when the contact between the probe and an object is poor. In particular, in the case of A-mode signals, unlike images obtained from B-mode ultrasonic signals or other audio data, distinguishment between good and bad data may be difficult, and the data quality of data used for training and inference may be poor. In this way, when the data quality is poor, it is conceivable that sufficient information for quality evaluation is not acquired, and the performance of quality evaluation is degraded. In this regard, the information processing apparatus according to the present embodiment can suppress the influence of A-mode ultrasonic data with low data quality, including noise, among A-mode ultrasonic data obtained from different measurement sites, and perform quality evaluation by analysis focusing on A-mode ultrasonic data with high quality. Accordingly, the information processing apparatus according to the present embodiment can analyze A-mode ultrasonic signals by eliminating the influence of noise and low-quality signals, and improve the performance of quality evaluation using the A-mode ultrasonic signals.

In addition, by using A-mode ultrasonic signals for each of different measurement sites, information appropriate for an inspection tailored to the measurement site can be acquired. For example, for tuna, information can be acquired for each part of the fish with or without guts. In this regard, the performance of quality evaluation using A-mode ultrasonic signals can also be improved.

### (b) Second Embodiment

A second embodiment is described below. The information processing apparatus 1 according to the present embodiment is also represented by the block diagram in FIG. 1. The information processing apparatus 1 according to the second embodiment has the feature extraction model 151 for each measurement site. In the following description, a description of the operation of each component similar to that of the first embodiment may be omitted.

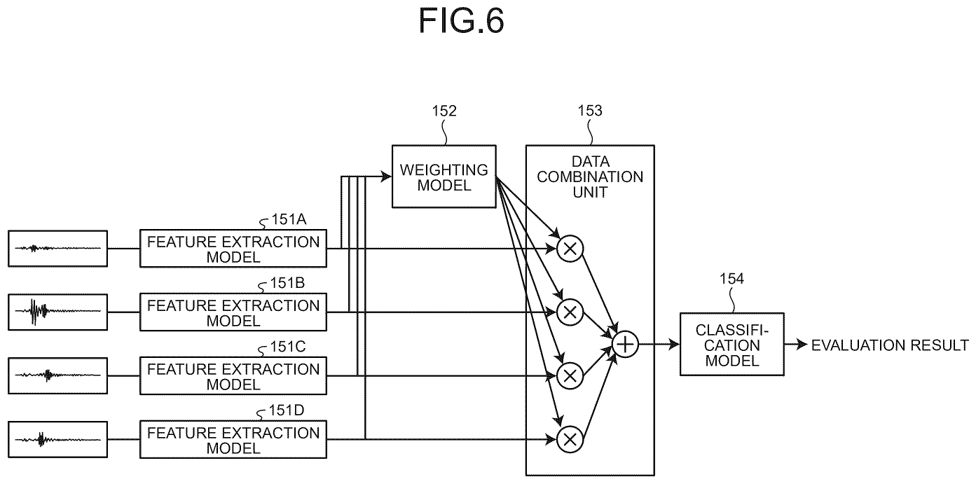

FIG. 6 is an image diagram of an entire quality inference process by an inference unit according to the second embodiment. The feature extraction model 151 according to the present embodiment has feature extraction models 151A to 151D corresponding to measurement sites, respectively. These feature extraction models 151A to 151D are examples of “a plurality of individual models”.

The feature extraction models 151A to 151D generate feature data by extracting features of A-mode ultrasonic signals acquired at different measurement sites of frozen tuna. For example, the feature extraction model 151A extracts features of the A-mode ultrasonic signals acquired by the ultrasonic probe 21. The feature extraction model 151B also extracts features of the A-mode ultrasonic signals acquired by the ultrasonic probe 22. The feature extraction model 151C also extracts features of the A-mode ultrasonic signals acquired by the ultrasonic probe 23. The feature extraction model 151D also extracts features of the A-mode ultrasonic signals acquired by the ultrasonic probe 24. That is, the process of generating the feature data includes a process of generating feature data for each of the plurality of A-mode ultrasonic signals by using the individual models corresponding to positions where the A-mode ultrasonic signals have been obtained.

The weighting model 152 receives the features of the A-mode ultrasonic signals at each measurement site of the frozen tuna extracted by the feature extraction models 151A to 151D. Subsequently, the weighting model 152 calculates and outputs weights corresponding to the features.

The data combination unit 153 weights each of the features of the A-mode ultrasonic signals at each measurement site of the frozen tuna obtained by the feature extraction model 151, and generates one piece of input data by combining the weighted features together.

The classification model 154 uses the one piece of input data generated by the data combination unit 153 to classify the quality of the frozen tuna being an object as good or bad, infers the quality evaluation of the frozen tuna, and outputs results of the inferred quality evaluation.

The training execution unit 12 generates training data 200 by assigning classification labels to the A-mode ultrasonic signals obtained from each measurement site, and collects the generated training data 200 to generate a training data set 210. Subsequently, the training execution unit 12 trains the feature extraction models 151A to 151D by using the training data set 210. There are two possible configurations for the feature extraction models 151A to 151D.

One is a configuration in which different independent feature extraction models 151A to 151D are used to extract features of the A-mode ultrasonic signals for each measurement site. In this case, the training execution unit 12 executes training by using the A-mode ultrasonic signals obtained at the measurement sites corresponding to the feature extraction models 151A to 151D, respectively. This allows the training execution unit 12 to perform training for extracting features specific to a measurement site corresponding to each of the feature extraction models 151A to 151D.

This configuration is effective when the differences in the A-mode ultrasonic signals obtained for each measurement site are large. However, the training data 200 used for training each of the feature extraction models 151A to 151D are those including A-mode ultrasonic signals obtained from corresponding measurement sites.

The other configuration of the feature extraction models 151A to 151D is a configuration in which all are common models. In this case, the training execution unit 12 may train each of the feature extraction models 151A to 151D by using all of the A-mode ultrasonic signals obtained for each measurement site. As an alternative method, the training execution unit 12 may train each of the feature extraction models 151A to 151D by repeating a process of training any one of the feature extraction models 151A to 151D and then sharing parameters among the feature extraction models 151A to 151D. In either training method, the training execution unit 12 can generate the feature extraction models 151A to 151D as common models.

This configuration is effective when the differences in the A-mode ultrasonic signals obtained for each measurement site are small. In this case, the training execution unit 12 can train the feature extraction models 151A to 151D by using more training data 200 than in the case of the configuration described above, so that overlearning can be suppressed.

As described above, the information processing apparatus according to the present embodiment has a separate feature extraction model for each measurement site, and extracts features. Moreover, the feature extraction models corresponding to the measurement sites can use machine learning models with different independent configurations, or can all use machine learning models with a common configuration.

By using independent feature extraction models in order to extract features of A-mode ultrasonic signals for each measurement site, features specific to each measurement site can be extracted. In addition, by using a common feature extraction model in order to extract features of A-mode ultrasonic signals for each measurement site, overlearning can be suppressed. In this way, the information processing apparatus according to the present embodiment can implement flexible feature extraction, perform inference according to the properties of obtained A-mode ultrasonic signals, and improve the performance of quality evaluation using the A-mode ultrasonic signals.

### Hardware Configuration

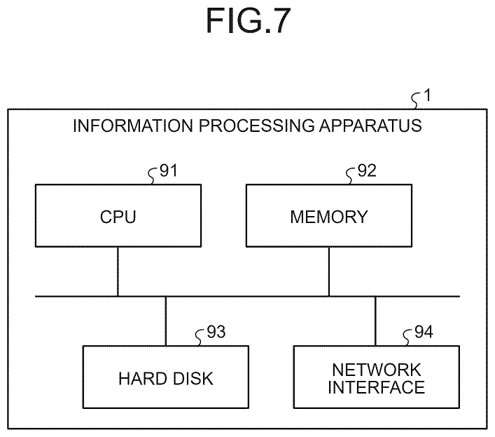

FIG. 7 is a hardware configuration diagram of the information processing apparatus. An example of a hardware configuration for implementing each function of the information processing apparatus 1 is described below with reference to FIG. 7.

As illustrated in FIG. 7, the information processing apparatus 1 has, for example, a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the information processing apparatus 1 and external devices. The network interface 94, for example, relays communication between external user terminal devices and the CPU 91.

The hard disk 93 is an auxiliary storage device. The hard disk 93 stores the feature extraction model 151, the weighting model 152, and the classification model 154 illustrated in FIG. 1. The hard disk 93 stores computer programs for implementing the functions of the measurement control unit 11, the training execution unit 12, the quality evaluation unit 13, the evaluation notification unit 14, and the inference unit 15 illustrated in FIG. 1.

The memory 92 is a main storage device. The memory 92 can use, for example, a dynamic random access memory (DRAM).

The CPU 91 reads various computer programs from the hard disk 93, loads the read computer programs into the memory 92, and executes the computer programs. This allows the CPU 91 to implement the functions of the measurement control unit 11, the training execution unit 12, the quality evaluation unit 13, the evaluation notification unit 14, and the inference unit 15 illustrated in FIG. 1.

According to one aspect of the computer-readable recording medium, the machine learning method, the inference method, and the information processing apparatus disclosed in the present application, the performance of quality evaluation using ultrasonic signals can be improved.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a machine learning program that causes a computer to execute a process comprising:
acquiring a training data set including a plurality of pieces of training data in which a plurality of A-mode ultrasonic signals obtained for each of different positions of an object are associated with evaluation results for the object; and
for each of the plurality of pieces of training data included in the training data set,
weighting a plurality of pieces of feature data acquired based on the plurality of A-mode ultrasonic signals included in the training data, by using a first machine learning model that weights feature data,
acquiring inference results of evaluation for the object by inputting the plurality of pieces of feature data weighted by the first machine learning model to a second machine learning model that outputs inference results of evaluation in response to input of the plurality of pieces of feature data, and
training the first machine learning model and the second machine learning model based on the inference results and the evaluation results in the training data.

2. The non-transitory computer-readable recording medium according to claim 1, wherein the process of acquiring the inference results of evaluation includes a process of acquiring the inference results of evaluation for the object by combining the plurality of pieces of weighted feature data together to generate one piece of input data and inputting the input data to the second machine learning model.

3. The non-transitory computer-readable recording medium according to claim 1, wherein
the computer is caused to further perform a process of generating feature data of each of the plurality of A-mode ultrasonic signals included in the training data by using a third machine learning model that generates feature data in response to input of the A-mode ultrasonic signals, and
the process of weighting includes a process of weighting the feature data obtained by the process of generating, by using the first machine learning model.

4. The non-transitory computer-readable recording medium according to claim 3, wherein
the third machine learning model includes a plurality of individual models corresponding to different positions of the object, and
the process of generating the feature data includes a process of generating the feature data of each of the plurality of A-mode ultrasonic signals by using the individual model corresponding to a position where each of the A-mode ultrasonic signals is obtained.

5. A non-transitory computer-readable recording medium having stored therein an inference program that causes a computer to execute a process comprising:
weighting a plurality of pieces of feature data acquired based on A-mode ultrasonic signals at different positions of an object, by using a trained first machine learning model that weights feature data, and
inferring evaluation for the object by inputting a plurality of pieces of weighted feature data to a second machine learning model that outputs inference results of the evaluation for the object in response to input of the plurality of pieces of feature data.

6. A machine learning method comprising:
acquiring a training data set including a plurality of pieces of training data in which a plurality of A-mode ultrasonic signals obtained for each of different positions of an object are associated with evaluation results for the object, and
for each of the plurality of pieces of training data included in the training data set,
weighting a plurality of pieces of feature data acquired based on the plurality of A-mode ultrasonic signals included in the training data, by using a first machine learning model that weights feature data,
acquiring inference results of evaluation for the object by inputting the plurality of pieces of feature data weighted by the first machine learning model to a second machine learning model that outputs inference results of evaluation in response to input of the plurality of pieces of feature data, and
training the first machine learning model and the second machine learning model based on the inference results and the evaluation results in the training data, by a processor.

7. An inference method comprising:
weighting a plurality of pieces of feature data acquired based on A-mode ultrasonic signals at different positions of an object, by using a trained first machine learning model that weights feature data and
inferring evaluation for the object by inputting a plurality of pieces of weighted feature data to a second machine learning model that outputs inference results of evaluation for the object in response to input of the plurality of pieces of feature data, by a processor.

8. An information processing apparatus comprising:
a memory to store
a first machine learning model that weights feature data acquired based on A-mode ultrasonic signals, and
a second machine learning model that outputs inference results of evaluation in response to input of a plurality of pieces of feature data; and
a processor coupled to the memory and the processor configured to:
acquire a training data set including a plurality of pieces of training data in which a plurality of A-mode ultrasonic signals obtained for each of different positions of an object are associated with evaluation results for the object, and
for each of the plurality of pieces of training data included in the training data set,
weight a plurality of pieces of feature data acquired based on the plurality of A-mode ultrasonic signals included in the training data, by using the first machine learning model,
acquire inference results of evaluation for the object by inputting the plurality of pieces of feature data weighted by the first machine learning model to the second machine learning model,
and train the first machine learning model and the second machine learning model based on the inference results and the evaluation results in the training data.

9. An information processing apparatus comprising:
A memory; and
a processor coupled to the memory and the processor configured to:
weight a plurality of pieces of feature data acquired based on A-mode ultrasonic signals at different positions of an object, by using a trained first machine learning model that weights feature data, and
infer evaluation for the object by inputting a plurality of pieces of weighted feature data to a second machine learning model that outputs inference results of the evaluation for the object in response to input of the plurality of pieces of feature data.
